(19) United States
(12) Patent Application Publication
(10) Pub. No.: US 2002/0112158 A1
(43) Pub. Date: Aug. 15, 2002

(54) Executable file protection

(76) Inventor: Andrey Vladimirovich Golchikov, Ekaterinburg (RU)

Correspondence Address: DANIEL J SWIRSKY, PO BOX 2345, BEIT SHEMESH, 99544, IL

(21) Appl. No.: 09/782,294

(22) Filed: Feb. 14, 2001

(51) Int. Cl. H04L 9/00

(52) U.S. Cl. 713/164

(57) ABSTRACT

A method of protecting and executing executable files, the method including protecting an executable file through either of compression and encryption, incorporating a protection descriptor into the executable file, the protection descriptor including information required for unprotecting the executable file, providing the protected executable file to unprotection and execution apparatus operative to unprotect the executable file, unprotecting the protected executable file at the unprotection and execution apparatus using the protection descriptor, and executing the unprotected execution file at the unprotection and execution apparatus.

### FIELD OF THE INVENTION

The present invention relates in general to methods and apparatus for protecting executable software files against unauthorized copying, patching, and reverse engineering.

### BACKGROUND OF THE INVENTION

The Executable and Linking Format (ELF) was originally developed and published by UNIX System Laboratories (USL) as part of the Application Binary Interface (ABI) and provides an object-code file format for linking and/or execution in operating system environments such as UNIX or Linux. The ELF standard was intended to streamline software development by providing developers with a set of binary interface definitions that extend across multiple operating environments, thus reducing the number of different interface implementations and, as a result, the need for recoding and recompiling code.

There are three main types of ELF object files: a relocatable file that contains code and data suitable for linking with other object files to create an executable or a shared object file; an executable file that contains a program suitable for execution; and a shared object file that contains code and data that may be linked with other relocatable and shared object files to create another object file, or with an executable file and other shared objects to create a process image. Executable ELF files may be run directly by the operating system kernel where they contain all code required for program execution, or may be run by an ELF interpreter that combines code in the ELF file with code from code libraries that are not part of the ELF file to form a combined application. In generals an ELF executable file can specify in the ELF program header the name of an ELF interpreter that is to control the environment for the application.

Techniques for compressing and/or encrypting executable software files and then uncompressing and/or decrypting them prior to execution are well known. Such techniques typically add uncompressed/decrypted executable code to the file containing the compressed/encrypted program. When the program is executed, the uncompressed/decrypted portion is executed first. This executable code is either itself capable of uncompressing/decrypting the compressed/encrypted remainder of the file, or else is capable of calling an external application which then uncompressed/decrypts the file. The file is then uncompressed/decrypted, placed into a temporary directory, executed, and then deleted after execution. Alternatively, the file is uncompressed/decrypted, placed directly into memory, and given execution control.

Such techniques suffer from the following drawbacks. Placing the uncompressing/decrypting executable code in the compressed/encrypted file increases file transmission overhead and storage overhead where multiple compressed/encrypted files reside on a single computer. Furthermore, upgrading the uncompressor/decrypter is impractical, if not possible, since the code of the uncompressor/decrypter is tightly connected to the protected software. Also, the uncompressor/decrypter in such a configuration will typically be written in assembly language and, therefore, will be extremely difficult to write and debug. On the other hand, if the uncompressor/decrypter is an external application, additional computing resources will be required to run it as a separate process from that of the protected software.

### SUMMARY OF THE INVENTION

The present invention seeks to provide novel methods and apparatus for protecting executable software files, particularly ELF executable files. In one aspect of the present invention software is incorporated into an interpreter, such as an ELF interpreter, for uncompressing/decrypting executable files, such as ELF files, that are compressed and/or encrypted prior to being executed. The uncompressor/decrypter software is loaded into the address space of the protected program, thus require no additional computing resources that would otherwise be needed were the uncompressor/decrypter to run as a separate process. By not including the uncompressor/decrypter software in the executable file, such as ELF file the storage/transmission overhead and upgrading problems of the prior art are avoided.

The present invention may be applied to ELF files in conjunction with an ELF interpreter, and, indeed, to any executable file that requires another application, such as an interpreter, for execution.

There is therefore provided in accordance with a preferred embodiment of the present invention a method of protecting and executing executable files, the method including protecting an executable file through either of compression and encryption, incorporating a protection de debtor into the executable file, the protection descriptor including information required for unprotecting the executable file, providing the protected executable file to unprotection and execution apparatus operative to unprotect the executable file, unprotecting the protected executable file at the unprotection and execution apparatus using the protection descriptor, and executing the unprotected executable file at the unprotection and execution apparatus.

Further in accordance with a preferred embodiment of the present invention the incorporating step includes including either of a compression key and an encryption key required to uncompress or decrypt the protected executable file in the protection descriptor.

Still further in accordance with a preferred embodiment of the present invention the method further includes encrypting the protection descriptor.

Additional in accordance with a preferred embodiment of the present invention the providing step includes providing the protected executable file to an interpreter.

Moreover in accordance with a preferred embodiment of the present invention the executable file is an ELF executable file and the interpreter is an ELF interpreter.

Further in accordance with a preferred embodiment of the present invention the unprotecting step further includes checking the protected executable file for the presence of non-standard program code and unprotecting the protected executable file only when the non-standard program code is present in the protected executable file.

Still further in accordance with a preferred embodiment of the present invention the providing step includes providing the protected executable file to a kernel module.

There is also provided in accordance with a preferred embodiment of the present invention a method of protecting and executing executable files, the method including protecting at least one function within an executable file through either of compression and encryption, thereby creating a protected portion corresponding to the at least one function, preceding the protected portion with a function call instruction to a dynanmic unprotector, executing the function call instruction, thereby executing the dynamic unprotector, unprotecting, at the dynamic unprotector, the protected portion, thereby creating an unprotected portion, overwriting the fuction call instruction and the protected portion with the unprotected portion, and executing the unprotected portion

Further in accordance with a preferred embodiment of the present invention the method further includes incorporating into the executable file a list identifying the protected function, the list describing any of the function length of the function, the compression method used to protect the function, the encryption method used to protect the function, and a key required to unprotect the protected portion, and the unprotecting step includes unprotecting using any information in the list.

Still further in accordance with a preferred embodiment of the present invention the method further includes providing the executable file to unprotection and execution apparatus, and the executing, unprotecting, and overwriting steps are performed by the unprotection and execution apparatus.

Additionally in accordance with a preferred embodiment of the present invention the protecting step includes protecting the at least one function within an executable file, and the providing step includes providing the executable file to an interpreter.

Moreover in accordance with a preferred embodiment of the present invention the executable file is an ELF executable file and the interpreter is an ELF interpreter.

There is also provided in accordance with a preferred embodiment of the present invention a method of protecting and executing executable files, the method including hashing at least one static portion of an executable file, thereby creating a cryptographic digest, encrypting, using the cryptographic digest, at least one execution parameter necessary for the execution of the executable fie, storing the encrypted execution parameter in the executable file, hashing the at least one static portion of the executable file, thereby recreating the cryptographic digest, decrypting, using the cryptographic digest, the at least one encrypted execution parameter, and executing the executable file using the decrypted execution parameter.

Further in accordance with a preferred embodiment of the present invention the encrypting step includes encrypting the address of an instruction that represents the entry point for execution of the executable file.

Still further in accordance with a preferred embodiment of the present invention the first hashing, encrypting, and storing steps are performed on a first computer, and the second hashing, decrypting, and executing steps are performed on a second computer.

Additionally in accordance with a preferred embodiment of the present invention he method further includes providing the executable file to unprotection and execution apparatus, and the first hashing, encrypting, and storing steps are performed by the unprotection and execution apparatus.

Moreover in accordance with a preferred embodiment of the present invention the first hashing, encrypting, and storing steps are performed on an executable file, and the providing step includes providing the executable file to an interpreter.

Further in accordance with a preferred embodiment of the present invention the executable file is an ELF executable file and the interpreter is an ELF interpreter.

It is appreciated throughout the specification and claims that the term “executable file” may include any file containing machine code instructions that may be executed by a computer in conjunction with another application. Such an application may be an interpreter, such as the ELF interpreter that is designed to provide an execution environment for executable files containing machine code instructions.

The disclosures of all patents, patent applications, and other publications mentioned in this specification and of the patents, patent applications, and other publications cited therein are hereby incorporated by reference.

### BRIEF DESCRIPTION OF THE DRAWINGS

The present invention will be understood and appreciated more fully from the following detailed description taken in conjunction with the appended drawings in which:

FIG. 1 is a simplified pictorial flow illustration of a method of protecting executable software files, operative in accordance with a preferred embodiment of the present invention;

FIGS. 2A and 2B, taken together, are a simplified pictorial flow illustration of a method of protecting executable software files using dynamic function unprotection, operative in accordance with a preferred embodiment of the present invention; and

FIGS. 3A and 3B, taken together, are a simplified pictorial flow illustration of a method of protecting executable software files using encryption, operative in accordance with a preferred embodiment of the present invention.

### DETAILED DESCRIPTION OF PREFERRED EMBODIMENTS

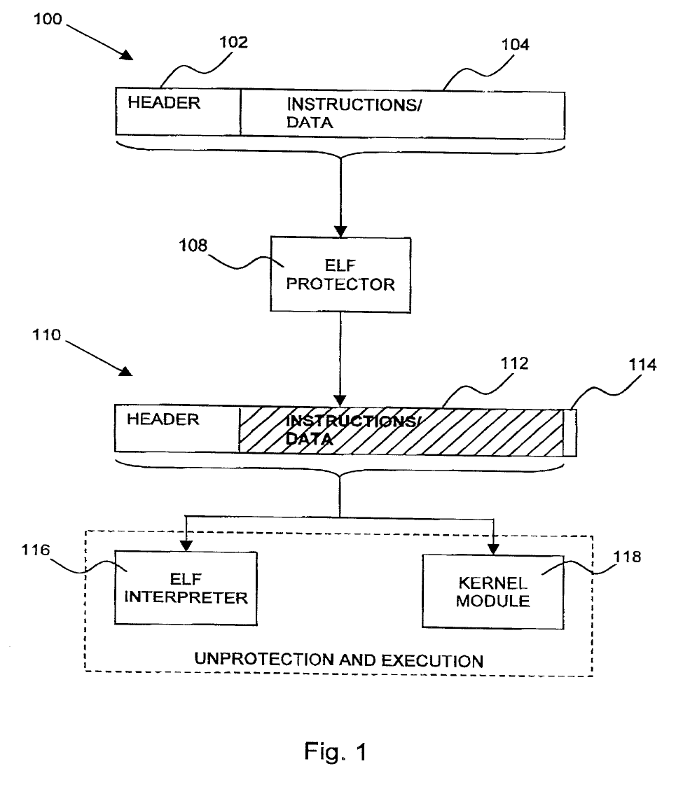

Reference is now made to FIG. 1, which is a simplified pictorial flow illustration of a method of protecting executable software files, operative in accordance with a preferred embodiment of the present invention. In the method of FIG. 1 an executable file 100, such as an ELF executable file, is shown including a header portion 102 and an instructions/data portion 104. File 100 is protected at an ELF protector 108 using any known file protection scheme, including known compression, encryption, or other protection measures, or otherwise as described herein, resulting in a protected executable file 110. Preferably, part or all of instructions/data portion 104 undergoes protection, with the protected portion 112 of file 110 shown in hatched lines. A protection descriptor 114 is incorporated into file 110 at any location therein and includes information that may be used to unprotect file 110, and thereby reconstruct unprotected file 100. Protection descriptor 114 may include compression or encryption key information required to uncompress or decrypt protected portions of file 110, with such information typically being itself encrypted using any known technique or otherwise as described herein. In order to execute file 110, the protected file 110 is provided to unprotection and execution apparatus, such as an ELF interpreter 116 or a kernel module 118, being configured to unprotect file 110 using the reverse method employed by protector 108, typically by decrypting and using the compression or encryption key information contained in protection descriptor 114.

In addition to being configured to execute protected ELF files, ELF interpreter 116 is preferably configured to execute standard ELF executable files that have not undergone protection as described hereinabove. ELF interpreter 116 typically distinguishes between protected and non-protected ELF files by checking each ELF file for the presence of non-standard program code.

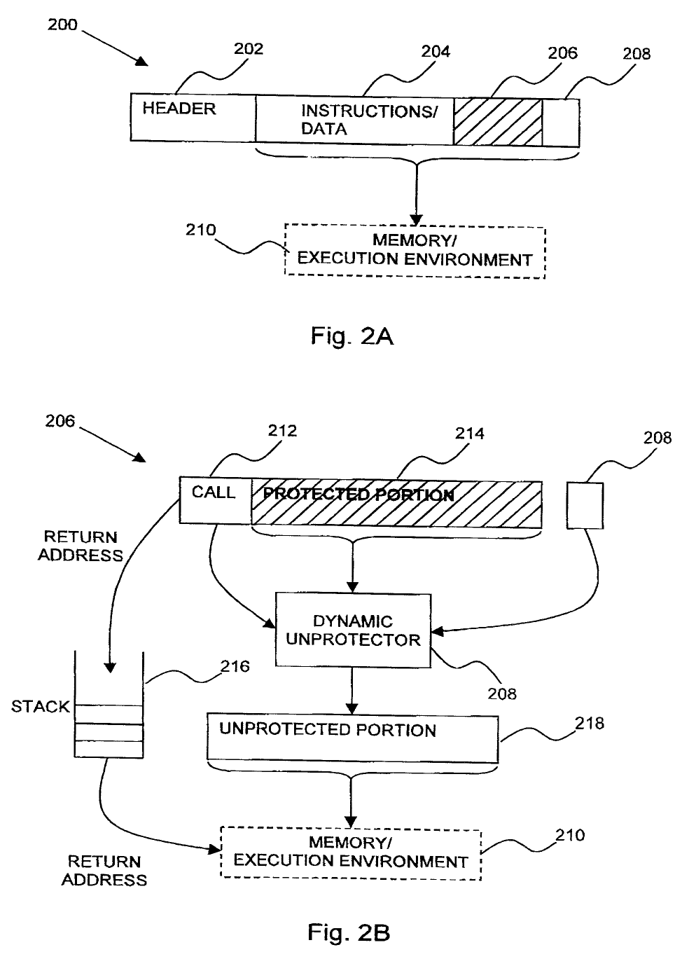

Reference is now made to FIGS. 2A and 2B, which, taken together, are a simplified pictorial flow illustration of a method of protecting executable software files using dynamic function unprotection, operative in accordance with a preferred embodiment of the present invention. In the method of FIGS. 2A and 2B, an executable file 200, such as an ELF executable file, is shown including a header portion 202 and an instructions/data portion 204 which includes a protected function 206 that may be dynamically unprotected. File 200 also includes a list 208 of those functions in instructions/data portion 204 that may be dynamically unprotected. Protected function 206 is preferably protected by ELF protector 108 as described hereinabove with reference to FIG. 1 and hereinbelow with reference to FIG. 2B, with file 200 typically being executed by ELF interpreter 116 or kernel module 118 in memory/execution environment 210 as described hereinbelow.

In FIG. 2B, protected function 206 is shown in greater detail as including a call instruction 212 followed by a protected portion 214. When protected function 206 is executed, the first instruction to be executed is the call instruction 212 which calls a dynamic unprotector function 208. Dynamic unprotector 208 may be incorporated into ELF interpreter 116 or kernel module 118 or may be an external function thereto. Using information in list 208 describing protected function 206, such as the function length, the compression and/or encryption method used to protect function 206, and/or the key or keys required to uncompress and/or decrypt protected portion 214, dynamic unprotector uncompresses and/or decrypts protected portion 214 into an unprotected portion 218, which is used to overwrite call instruction 212 and protected portion 214 in memory/execution environment 210. The return address of the call instruction 212, having been placed on a stack 216, is used to calculate the first instruction address of the unprotected portion 218, to which execution control is transferred. Protected function 206 is thus unprotected and may be executed normally.

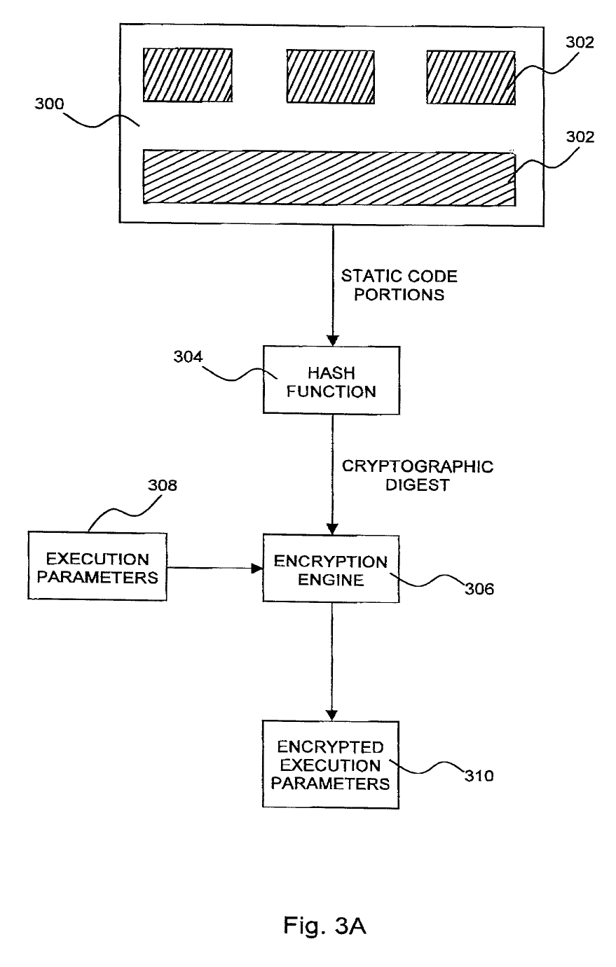

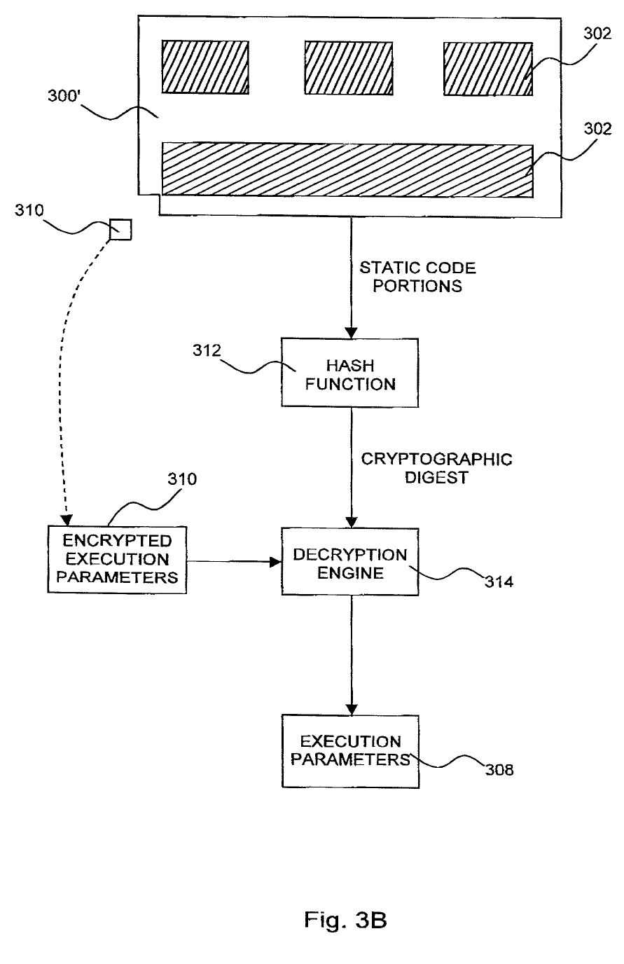

Reference is now made to FIGS. 3A and 3B, which, taken together, are a simplified pictorial flow illustration of a method of protecting executable software files using encryption, operative in accordance with a preferred embodiment of the present invention. In the method of FIG. 3A, an executable file 300, such as an ELF executable file, is shown including one or more dynamic code portions 302, shown in hatched lines, such as code that is to undergo address relocation or protected functions described hereinabove. Static portions of file 300, shown in white outside of dynamic portions 302, represent code that does not undergo relocation or other transformations before hash function calculation. One or more static portions of file 300 are input to a hash function 304 which computes a cryptographic digest from the static portions. The cryptographic digest is then input into an encryption engine 306 which uses the cryptographic digest to encrypt one or more execution parameters 308, creating encrypted execution parameters 310. The encrypted execution parameters 310 are then added to file 300 to create a file 300′ (FIG. 3B). Execution parameters 308 represent parameters of file 300 that are necessary for the execution of file 300′ and without which file 300′ could not be executed properly or at all, such as the address of the instruction that represents the entry point for execution of file 300′. Hash fiction 304 and encryption engine 306 are preferably incorporated into ELF protector 108 (FIG. 1).

Referring now to FIG. 3B, upon execution of file 300′, such as at ELF interpreter 116 or kernel module 118 (FIG. 1), portions of file 300′ corresponding to the same static portions of file 300 used by hash unction 304 (FIG. 3A) to compute the cryptographic digest are loaded into memory and used by a hash function 312 (FIG. 3B), which is identical to hash function 304, to recreate the cryptographic digest. The encrypted execution parameters 310 are not used to recreate the cryptographic digest. The cryptographic digest is then input into a decryption engine 314 which uses the cryptographic digest to decrypt the encrypted execution parameters 310. If the static portions of the file were not changed, such as by unauthorized tampering or hacking, the original execution parameters 308 will be recreated including, preferably, the address of the entry point for execution of file 300′. Otherwise, the original execution parameters 308 will not be successfully recreated, resulting in an incorrect address of the entry point for execution of file 300′. Where the original execution parameters 308 are successfully recreated, file 30′ may then be executed normally using the decrypted execution parameters 308. Hash function 312 and decryption engine 314 are preferably incorporated into ELF interpreter 116 or kernel module 118.

It is appreciated that one or more steps of any of the methods described herein may be implemented in a different order than that shown while not departing from the spirit and scope of the invention.

While the methods and apparatus disclosed herein may or may not have been described with reference to specific hardware or software, the methods and apparatus have been described in a manner sufficient to enable persons having ordinary skill in the art to readily adapt commercially available hardware and software as may be needed to reduce any of the embodiments of the present invention to practice without undue experimentation and using conventional techniques.

While the present invention has been described with reference to one or more specific embodiments, such as ELF files and ELF interpreters, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention. For example, the present invention may be applied to any executable file that requires another application, such as an interpreter, for execution.

What is claimed is:

1. A method of protecting and executing executable files, the method comprising:
protecting an executable file through either of compression and encryption;
incorporating a protection descriptor into said executable file, said protection descriptor including information required for unprotecting said executable file;
providing said protected executable file to unprotection and execution apparatus operative to unprotect said executable file;
unprotecting said protected executable file at said unprotection and execution apparatus using said protection descriptor; and
executing said unprotected executable file at said unprotection and execution apparatus.

2. A method according to claim 1 wherein said incorporating step comprises including either of a compression key and an encryption key required to uncompress or decrypt said protected executable file in said protection descriptor.

3. A method according to claim 1 and further comprising encrypting said protection descriptor.

4. A method according to claim 1 wherein said providing step comprises providing said protected executable file to an interpreter.

5. A method according to claim 4 wherein said executable file is an ELF executable file and wherein said interpreter is an ELF interpreter.

6. A method according to claim 4 wherein said unprotecting step further comprises checking said protected executable file for the presence of non-standard program code and unprotecting said protected executable file only when said non-standard program code is present in said protected executable file.

7. A method according to claim 1 wherein said providing step comprises providing said protected executable file to a kernel module.

8. A method of protecting and executing executable files, the method comprising:
protecting at least one function within an executable file through either of compression and encryption, thereby creating a protected portion corresponding to said at least one function;
preceding said protected portion with a function call instruction to a dynamic unprotector;
executing said function call instruction, thereby executing said dynamic unprotector;
unprotecting, at said dynamic unprotector, said protected portion, thereby creating an unprotected portion;
overwriting said function call instruction and said protected portion with said unprotected portion; and
executing said unprotected portion.

9. A method according to claim 8 and further comprising incorporating into said executable file a list identifying said protected function, said list describing any of the function length of said function, the compression method used to protect said function, the encryption method used to protect said function, and a key required to unprotect said protected portion, wherein said unprotecting step comprises unprotecting using any information in said list.

10. A method according to claim 8 and further comprising providing said executable file to unprotection and execution apparatus, and wherein said executing, unprotecting, and overwriting steps are performed by said unprotection and execution apparatus.

11. A method according to claim 10 wherein said protecting step comprises protecting said at least one function within an executable file, and wherein said providing step comprises providing said executable file to an interpreter.

12. A method according to claim 11 wherein said executable file is an ELF executable file and wherein said interpreter is an ELF interpreter.

13. A method of protecting and executing executable files, the method comprising:
hashing at least one static portion of an executable file, thereby creating a cryptographic digest;
encrypting, using said cryptographic digest, at least one execution parameter necessary for the execution of said executable file;
storing said encrypted execution parameter in said executable file;
hashing said at least one static portion of said executable file, thereby recreating said cryptographic digest;
decrypting, using said cryptographic digest, said at least one encrypted execution parameter; and
executing said executable file using said decrypted execution parameter.

14. A method according to claim 13 wherein said encrypting step comprises encrypting the address of an instruction that represents the entry point for execution of said executable file.

15. A method according to claim 13 wherein said first hashing, encrypting, and storing steps are performed on a first computer, and wherein said second hashing, decrypting, and executing steps are performed on a second computer.

16. A method according to claim 13 and further comprising providing said executable file to unprotection and execution apparatus, and wherein said first hashing, encrypting, and storing steps are performed by said unprotection and execution apparatus.

17. A method according to claim 16 wherein said first hashing, encrypting, and storing steps are performed on an executable file, and wherein said providing step comprises providing said executable file to an interpreter.

18. A method according to claim 17 wherein said executable file is an ELF executable file and wherein said interpreter is an ELF interpreter.
